(19) United States
(12) Patent Application Publication
(10) Pub. No.: US 2022/0126955 A1
(43) Pub. Date: Apr. 28, 2022

(54) Device For Filtering Micropollutants From Liquid Environments

(71) Applicant: GABRIELLA ANN LOUISE PLEASANT, TEMECULA, CA (US)

(72) Inventor: GABRIELLA ANN LOUISE PLEASANT, TEMECULA, CA (US)

(21) Appl. No.: 17/512,644

(22) Filed: Oct. 27, 2021

Related U.S. Application Data
(63) Continuation-in-part of application No. 63/106,735, filed on Oct. 28, 2020.

(51) Int. Cl. B63B 35/32; B09B 3/60

(52) U.S. Cl. CPC B63B 35/32; B09B 2101/75; B09B 3/60

(57) ABSTRACT

A device and method for cleaning polluting particles and debris out of a body of liquid using a swimming robot which catches debris with filters and chemically reduces the caught debris into a preferred byproduct before ejecting the byproduct back into the environment. In a preferred embodiment and application, a swimming robot made of biodegradable materials and equipped with non-toxic enzymes for chemically reducing plastics is placed into the ocean to swim around, propelled by wave motion, and safely remove plastics, particularly including microplastics, from the environment and convert the filtered plastics into a benign byproduct, until the device itself wears out and harmlessly breaks down without being recovered or polluting the environment further.

### CO-PENDING PATENT APPLICATION

This Nonprovisional patent application is a Continuation-in-Part patent application to Provisional Patent Application Ser. No. 63/106,735 as filed on Oct. 28, 2020 by Inventor Gabriella Ann Louise Pleasant titled “Device For Filtering Micropollutants From Liquid Environments”. Provisional Patent Application Ser. No. 63/106,735 is hereby incorporated into its entirety and for all purposes into the present disclosure.

### FIELD OF THE INVENTION

The present invention relates generally to aquatic filtering and cleaning devices, and specifically to an oceangoing robot designed to catch and dissolve polluting debris.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The prevalence of human-made debris, especially plastic debris, polluting the world's oceans is a decades-old ecological tragedy: killing wildlife by the hundreds and thousands, wrecking ocean habitats in catastrophic ways, and poisoning even humanity's own food supply. The experts at oceanconservancy.org estimate that about 8 million metric tons of plastic goes into the ocean every year. Much of this plastic debris is microplastics, i.e., plastic fragments less than 5 mm in length that break off of larger pieces or even fall off of synthetic fabrics when these are washed, and microplastics in particular have been eluding other means of water filtration, and getting consumed at every level of the food chain in significant quantities, with untold results.

Efforts to address the oceans' plastic problems include small-scale everyday efforts such as beach cleanups and household recycling; legislative initiatives to limit the amount of plastic manufactured or thrown away, such as bans on single-use plastics like straws and plastic bags; and larger-scale efforts by ecological organizations, such as multiple technological projects to dismantle the infamous Great Pacific Garbage Patch.

It's fairly safe to say that nobody believes having huge amounts of plastic in the ocean and environment is an optimal situation, but so far, efforts to address the problem have fallen short of a satisfactory solution, as there is still a huge volume of plastic littering the ocean.

There is, therefore, a long-felt need to provide further and more ingenious solutions to this urgent and pernicious global problem.

### SUMMARY OF THE INVENTION

Towards these and other objects of the method of the present invention (hereinafter, “the invented method”) that are made obvious to one of ordinary skill in the art in light of the present disclosure, what is provided is an aquatic device (hereinafter, “the invented device”) for catching and chemically reducing plastics and other oceanic debris.

A preferred embodiment of the invented device consists of a casing adapted or shaped to filter floating trash, such as microplastics, from liquid in which the device is submerged, and to deposit the caught debris in an internal ‘stomach’ bladder or casing containing means for dissolving the caught debris such as chemicals, enzymes, or bacteria. One preferred application of the invented device is the releasing of a floating or paddling embodiment of the invented device into the ocean, such that the device may ‘swim’ or float around, filtering out trash and cleaning the ocean of debris and pollution, until the biodegradable and nontoxic device eventually wears out and decomposes harmlessly into the surrounding environment.

In accordance with this preferred application, preferred embodiments of the invented device include such features as biodegradable materials and other biodegradable or nontoxic components, and limiting of chemicals included in the stomach to those that are not harmful if spilled or leaked into the ocean or ingested by animals. In preferred application, the invented device may be released into the ocean and forgotten, left to safely decompose after scooping up and dissolving all of the debris it can reach. It should be understood throughout this disclosure that embodiments that can be safely abandoned at sea are strongly preferred unless otherwise indicated, and are disclosed as the ideal mode for manufacturing and implementing the invented device, but versions of this same invention made of less eco-friendly materials should still be considered embodiments of the invention, but inferior, less-responsible ones, not distinct by virtue of departure from this preferred aspect of the invention.

Some preferred embodiments of the invented device might include a means of locomotion for propelling the invented device around the ocean, powered by wave motion or other available means. The invented device might also be unpowered, and simply drift wherever the currents of the ocean happen to flow. Reasons for having a powered device might include remote control of the device, directing the device to seek a particularly polluted part of the ocean such as near a garbage patch rather than drift along just anywhere, or enabling of additional features that require power such as a GPS beacon or other similar useful features. It is noted that inclusion of a battery or other usual aspects of a powered device would require discretion and possible further innovation to responsibly include in a device made to biodegrade harmlessly in the ocean, and sacrificing the biodegradability of the device in order to add powered features is not generally preferred as an embodiment of the invented device.

Some embodiments of the device are sufficiently lightweight to float on or near the surface without additional buoyancy aids such as air bladders, while other devices might be made of heavier material but include air bladders for flotation. Other embodiments of the invented device might be designed to float at a deeper depth, and include ballast or air bladders suited to maintaining the designed depth instead. For embodiments of the invented device intended to float at a shallow depth, one or more translucent panels in the casing might optimally be included to stimulate and accelerate the chemical processes of the stomach by warming the inside of the device with sunlight.

Certain further embodiments of the invented device might include an internal channel lined with enzyme-bearing material, allowing liquid to filter through, unobstructed by an enclosed stomach bladder.

Preferred embodiments of the invented device might be shaped like or structurally mimic features of marine animals, either for aesthetic reasons or to borrow techniques for maneuvering through and filtering prey out of water that are already successful in nature. One preferred embodiment may be shaped to resemble a turtle, having a ‘mouth’ to catch debris, a clear or translucent ‘shell’ over the enzyme-filled stomach, and ‘flippers’ to provide buoyancy, stability, and movement. Another design may be similar to a filter-feeding whale, using enzyme-coated ‘teeth’ to filter debris out of water flowing through an open cavity. Yet another embodiment may borrow a jellyfish's technique of capturing prey with a plurality of tendrils spread out in the water, then in some embodiments conveying the captured prey (in the device's case, trash, not fish) to the central ‘stomach’. These variations may provide optimized approaches for processing different sizes and varieties of debris, for traversing different kinds of liquid environments, or for adding or excluding additional possible features based on preference or situation. It is noted that a biodegradable, ocean-safe device embodiment would be safe to ingest if a natural predator of one of these imitated animals mistook the device for prey.

The device's means for filtering debris out of the water might be any suitable means known in the art, and could include shaping of the device casing to trap particles, providing material that might serve as a strainer such as fabric mesh or closely-spaced protrusions on the casing, or coating of selected surfaces with enzymes to dissolve encountered debris upon contact. Other suitable techniques for accomplishing this might already be known in the art or be invented in the future, and various embodiments of the device might include optimization of the filtering technique as relevant to different sizes or varieties of debris or liquid environment.

One further notes that the utility of a device that traverses or is situated in a body of liquid and filters out particles or substances unsupervised would not be limited to ocean cleanup. Other applications might include the everyday convenience of an embodiment of the invention that can be set loose in one's swimming pool and keep the pool water maintained over time, or the clear benefit of a model that could be set loose to operate independently and gather up liquid-borne material as needed in hazardous liquid environments such as toxic or radioactive areas. One notes that an embodiment intended for use in a non-water liquid environment naturally might be better constructed of materials suited to traversing that environment and accomplishing the desired task. Additionally, the chemicals or enzymes in the stomach compartment might be varied to provide a different effect besides dissolving of plastic, such as dissolving something else that shouldn't be in that environment, coagulating caught ‘junk’ into clumps large enough to harmlessly sink to the bottom or float to the surface, neutralizing or dampening radioactivity, or any other chemical or enzyme processing that might be done in the claimed context, including none at all. A further embodiment might be imagined where the device gathers up material in a body of liquid and is then retrieved and emptied so the user can keep what is gathered; for instance, a valuable mineral present as particles in the liquid, such as gold dust in water. Another application that may be emphasized in early development as a possible introductory market is use of the invented device(s) as an extra layer of filtration at commercial water purification plants or as an extra layer in consumer water filters. The present disclosure focuses primarily upon oceangoing embodiments that filter out and dissolve waste plastics, but one skilled in the art will recognize that the advancement in the art represented by the present invention is widely applicable and embodiments of the described invention might be applied to many different purposes and contexts by fairly obvious variation upon the invented design as disclosed herein. It is noted that a device which successfully catches debris to process will generally require some means of excreting the byproducts of that processing, or the device may fill up and run out of room for newly-caught debris. In certain alternate preferred embodiments, the debris is chemically reduced such that the byproduct is benign and can float back out into the environment, such as plastic debris dissolved into a non-toxic liquid. In some possible embodiments, suited to an enclosed body of liquid like a swimming pool or an embodiment in which the device is used to collect material, one might re-catch the device and simply empty the stomach out manually. In still other preferred embodiments, the device may catch harmful pollution and render the caught material inert without being able to expel the byproduct, and may fill up completely and be unable to take in any more material, but when the device eventually decomposes and releases the contents, the pollution will still have been rendered at least less harmful even if the device spent most of its life span swimming around full of material.

One appreciates the particulars of this design as offering the further possible benefit of pluralizing this automated environmental cleanup. A large number of these simple devices might be manufactured relatively cheaply, potentially funded or ‘adopted’ by ordinary people with a concern for ecology and a few extra dollars, and released off the end of a wharf or from a boat, either individually or by the batch, as a direct, tangible, and physical contribution to the health of our oceans, however small individually, that almost anybody can make.

It is noted that variations in the size and shape of the invented device are generally toward the aim of improving the device's ability to move and operate effectively in the particular environment the device is employed in, and therefore small variations upon the basic concept of this invention may be as numerous as liquid environments that may benefit.

Early embodiments in particular may prioritize some of the most common varieties of plastic found in ocean water, namely, polyethylene 3AJ8, polypropylene 3U91, and polystyrene 3QQT. Based on present understanding, some preferred elements for use in the stomach of the invented device for breaking down polyethylene 3AJ8 may include Pestalotiopsis microspora, Schizophyllum commune, Pleurotus ostreatus, and Ideonella sakaiensis F-6. Based on present understanding, some preferred elements for use in the stomach of the invented device for breaking down polypropylene 3U91 may include Bacillus subtilis and Sporosarcina globispora. Based on present understanding, the preferred elements for use in the stomach of the invented device for breaking down polystyrene 3QQT may include Pseudomonas putida. It is understood that the elements mentioned above as currently preferred or anticipated to be preferable do not constitute an exhaustive listing, nor does the above listing indicate or specify a limitation that these elements must be among those used or that no other elements could be used besides these. Other elements may be found suitable for use in this context, particularly if a different variety of plastic or debris is prioritized instead or in addition to those mentioned above, and it's also possible that one or more of the above-listed elements listed as thought likely to be preferable may be found unsuitable or unfeasible and not used.

It is noted that ocean pollution travels with the currents, and the movements of oceanic debris, including formation of phenomena such as the Great Pacific Garbage Patch (which has formed inside the North Pacific Subtropical Gyre) are generally a function of how the system of ocean currents works already. It is further noted also that a mobile embodiment of the invented device would follow those same movement patterns, drifting on the currents, and thus be likely to ‘follow the trash’ even if not powered or otherwise able to propel itself, and that a stationary version of the invented device might be strategically positioned in known and predictable oceanic currents to have a good chance of encountering debris worth catching.

It is noted that, while many varieties and embodiments of the invented device are mobile, a stationary device utilizing the novel filtering and material-reducing methods presented herein may also be a novel and nonobvious embodiment of the present invention. Such a model as this may be particularly useful within a closed environment, such as a water treatment facility, or might be strategically positioned in a particular waterway or current, such as a river or a major ocean current like the Gulf Stream, to catch debris flowing through. It is further noted that bivalves, tunicates, barnacles, sponges, and other stationary filter-feeding creatures are also able to filter enough moving water while staying in one position to be able to survive and thrive, and unfortunately but predictably, these creatures can take in quite a lot of pollution this way also. Indeed, experts hold that microplastic pollution in particular is likely to disproportionately threaten filter feeding animals, swimming and stationary, as the majority of microplastic debris is about the same size as their usual diet of plankton. Therefore, an embodiment of the invented device might be usefully employed for providing filter cleanup in this niche also, let alone how useful this embodiment may be in other liquid filtration contexts. It is noted that a ‘fixed position’ ocean filter such as this might be emplaced at the bottom of a harbor or otherwise stationed conveniently close to a coastline and periodically maintained over time with relative ease, and therefore an embodiment like this might more safely be constructed of non-biodegradable materials and used as a long-term fixture.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

The detailed description of some embodiments of the invention is made below with reference to the accompanying figures, wherein like numerals represent corresponding parts of the figures.

FIG. 1 is a side view diagram of an invented swimming device;

FIG. 2 is an interior side view diagram of the invented swimming device of FIG. 1;

FIG. 3 is a front view diagram of the invented swimming device of FIG. 1 with a system of interior filters attached;

FIG. 4 is a rear view diagram of the invented swimming device of FIG. 1 with the interior filters attached;

FIG. 5 is a diagram of the inside of the bottom side of the invented swimming device of FIG. 1;

FIG. 6 is a view of the inside of the top side of the invented swimming device of FIG. 1;

FIG. 7 is a side view diagram of the digestion system of the invented swimming device of FIG. 1, including the interior filters set inside the stomach chamber;

FIG. 8 is an interior view diagram of the front of the invented swimming device of FIG. 1 with the interior filters attached;

FIG. 9 is an interior view of the back of the invented swimming device of FIG. 1 with the interior filters attached;

FIG. 10 is a diagram of a paddle system of the invented swimming device of FIG. 1, with paired top and side views of each paddle shape;

FIG. 11 shows the chemical interactions that will occur within the invented swimming device of FIG. 1, for both an interior stomach chamber and an exterior filter system;

FIG. 12 shows a set of lenses that will attach to the exterior casing of the invented swimming device of FIG. 1, and a set of gas-filled sacs that will attach to the exterior casing of the invented swimming device of FIG. 1;

FIG. 13 shows a side view of the invented swimming device of FIG. 1 with the system of exterior filters attached through a set of biodegradable screws;

FIG. 14 shows an interior view of the invented swimming device of FIG. 1 with the interior filters as well as the exterior filters attached with biodegradable screws;

FIG. 15 shows one of the exterior filters and one of the biodegradable screws of FIG. 14;

FIG. 16 shows a side view of the invented swimming device of FIG. 1 with the exterior filters attached to the exterior casing as a single piece;

FIG. 17 is a side view of a third invented device, which is a stationary embodiment of the invention; and

FIG. 18 is a detail view of the filter layers of FIG. 17.

### DETAILED DESCRIPTION OF DRAWINGS

In the following detailed description of the invention, numerous details, examples, and embodiments of the invention are described. However, it will be clear and apparent to one skilled in the art that the invention is not limited to the embodiments set forth and that the invention can be adapted for any of several applications.

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims. Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the range's limits, excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

Throughout this specification, like reference numbers signify the same elements throughout the description of the figures.

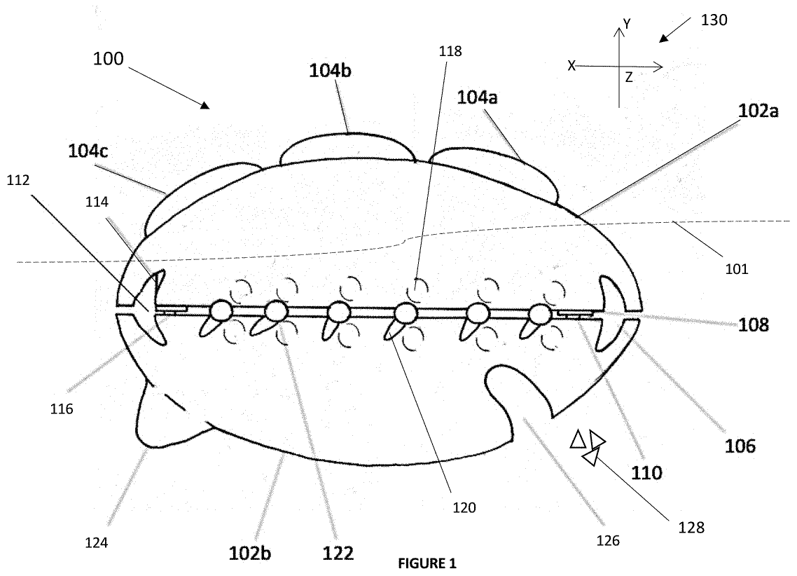

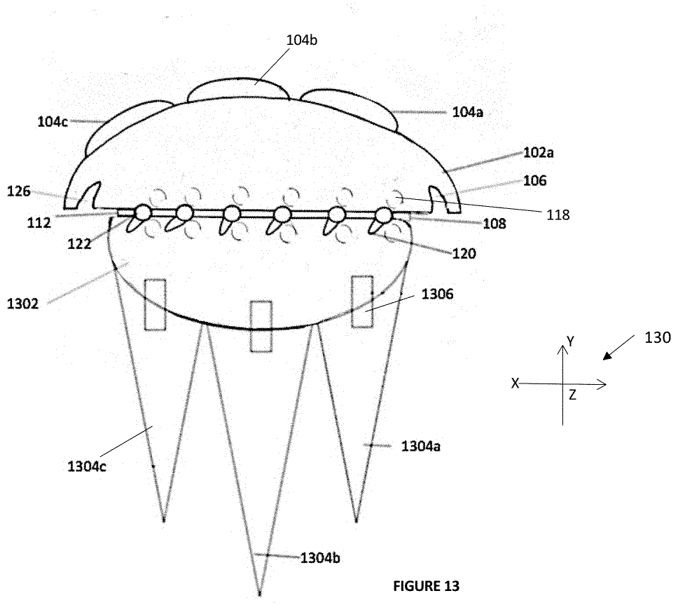

Referring now generally to the Figures and particularly to FIG. 1, FIG. 1 is a side view of an invented swimming device 100 that traverses and filters liquid 101 from a surrounding liquid environment such as the ocean. It is noted that, while depiction of the liquid 101 in FIG. 1 indicates a ‘water line’, the device 100 may be designed to traverse the liquid 101 at any depth, and this depiction is only for purposes of clarity in explanation. The invented swimming device 100 has an exterior casing 102 that is divided into a top exterior casing 102a and a bottom exterior casing 102b. The current size of the prototype for the top and bottom exterior casing are 69.16 millimeters wide, but the invention might be scaled to any size. The bottom exterior casing 102b may be equal in size and shape to the exterior casing 102a as presented here, or be a smaller lower exterior casing 1302 as presented in FIG. 13 and attached to one or more exterior filters 1304 of FIG. 13. Other variations in size and shape based upon this basic design are also possible and obvious, and nothing regarding the exact shape of the casing should be construed as limiting.

The invented swimming device 100 may further include one or more lenses 104, which are translucent panels facing the surface of the liquid environment in which the device 100 is swimming. The lenses 104 can allow sunlight from the surface into the device 100 and warm the interior of the device 100, encouraging the chemical processes of the device 100 to progress faster.

A preferred embodiment of the top exterior casing 102a is conical in shape, thus allowing a body of liquid 101 to flow underneath the top exterior casing 102a and increase overall buoyancy. The two casing halves may be fastened together by means of either cylindrical pieces fitting into shaped apertures as described in FIG. 1, or alternatively by screw-shaped pieces as described in FIG. 13. The bottom half of the casing may not be present at all, or present as a narrow cover over the filters. Presented in FIG. 1 are a front aperture 106 containing a front large cylinder 108 piece into which fits a front small cylinder 110 piece, and a rear aperture 112 containing a rear large cylinder 114 into which fits a rear small cylinder 116. One or more screws 1306 of FIG. 13 may alternatively be fastened into the larger cylinders 108 and 114 to couple the casing of the device 100 together.

There are other embodiments that may combine the two exterior casings 102a and 102b in another way, such as manufacturing the casing 102 as a single piece. The preferred embodiment keeps the exterior casing halves 102a and 102b separate during construction to allow for manually opening the device 100 and fitting features such as filters into the interior of the device.

The locomotion system of the device 100 may include a plurality of raised bumps 118 on the exterior of the casing 102, a plurality of paddles 120a-122k which are moved by the motion of the liquid 101 such as wave motion, and a rudder 124. The paddles 120 are restricted by the bumps 118 from moving the device 100 in a less desired direction, thus steering the device 100 without need for a motor or power source, such that the surrounding liquid 101 enters the device 100 through a front opening 126 when the device 100 moves forward (i.e., toward the front) through the liquid 101. A plurality of debris 128 present in the liquid 101 may flow into the device 100 as the device 100 swims through the liquid 101.

According to the invented method, the swimming device 100 is propelled through the liquid 101, such as the ocean or another body of liquid to be filtered by the swimming device 100, by movement of the liquid 101 around the exterior of the swimming device 100. When the liquid 101 moves over the paddles 120a-122k, the paddles are moved also, thus propelling the device. The exterior casing 102 includes a plurality of raised bumps 118 to prevent full 180 degree motion of the paddles 120a-122k. Preventing full movement of the paddles causes the swimming device 100 to be propelled forward but not equally propelled backward by the motion of the liquid 101. The paddles 120a-122k and rudder 124 are particularly preferred for fast-moving bodies of liquid 101.

FIG. 1 further includes an XYZ compass 130, presenting an X axis, Y axis, and Z axis as labeled. The X axis is mutually orthogonal both to the Y axis and to the Z axis. The Y axis is mutually orthogonal to both the X axis and the Z axis. The Z axis is mutually orthogonal to both the X axis and the Y axis. For the purposes of standardizing terminology in this disclosure, the X axis is the ‘front-to-back’ dimension relative to the device 100, and runs substantively parallel (allowing for waves) to the surface of the liquid 101. The point of the casing 102 pointed toward the device's 100 direction of travel is considered the front of the device 100. The Y axis is the dimension of ‘up and down’, such that the Y axis is substantively orthogonal to the surface of the liquid 101 and such that movement along the Y axis is either upward toward the sky or downward deeper into the liquid 101. The Z axis is the ‘side-to-side’ dimension, and runs parallel to the surface 108 and orthogonal to the other two axes. The XYZ compass 130 further includes an arrowhead on the X axis line indicating direction of travel (i.e., which way is the front of the device 100), and an arrowhead on the Y axis line indicating the direction of up (i.e., which way is the top of the device 100). There is no arrowhead on the Z axis. In FIG. 1, the Z axis is oriented directly toward the viewer, and is therefore represented by a ‘Z’ close to the intersection of the Z and Y axes. All instances of the XYZ compass 130 appearing in other Figures follow the same conventions stated above.

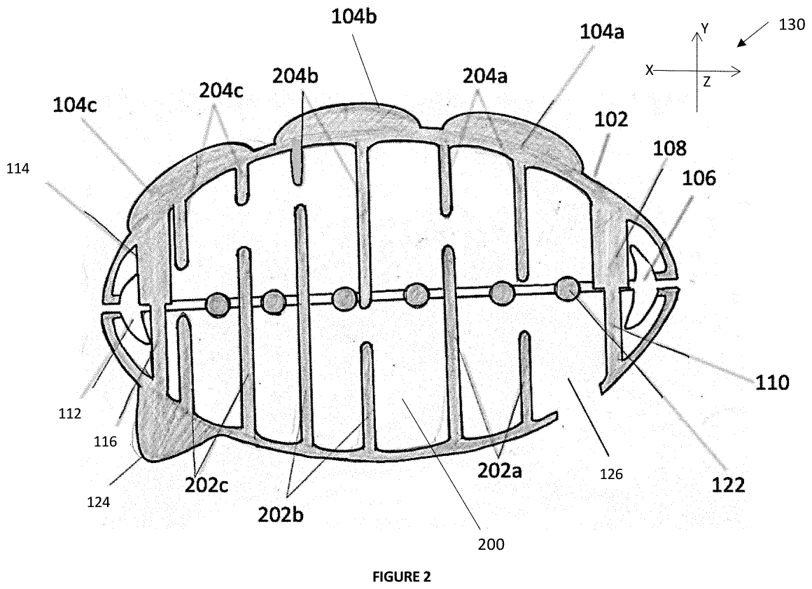

Referring now generally to the Figures and particularly to FIG. 2, FIG. 2 is a cutaway side view of the invented swimming device 100. The invented swimming device 100 includes the exterior casing 102 surrounding a stomach chamber 200, the front aperture 106, the rear aperture 126, a plurality of lower interior filters 202 and a plurality of upper interior filters 204, the paddles 120a-122k, a rudder 124, and the three top lenses 104.

Some preferred materials out of which the invented swimming device 100 may be constructed include chitosan and cellulose, for their abundance and biodegradability. Other embodiments may be produced with other biodegradable materials, including mixtures that do not contain chitosan or cellulose. One further preferred material under consideration may be the material known commercially as MycoComposite, which is a newly developed packaging material made from mushrooms that can be custom-grown into a preferred shape. The preferred embodiment may be also coated in beeswax, in order to slow the natural degradation process of biodegradable materials, and thus keep the device in action for a longer period of time. Other embodiments may be coated in other water-repellent materials, but for the preferred embodiment beeswax has been chosen due to its biodegradability and few if any harmful side effects to marine environments.

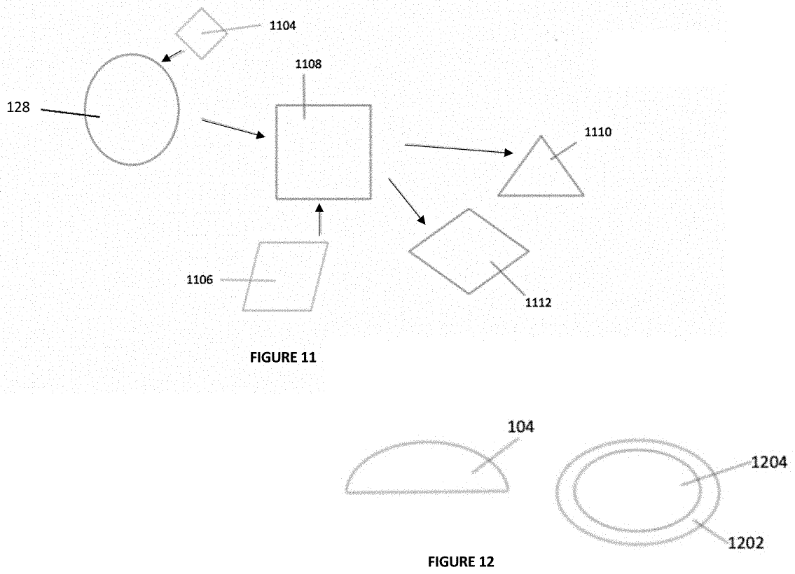

The front opening 126 is aligned with a first lower interior filter or filters 202a so that a maximum volume of the liquid 101 is maneuvered into contact with the interior filter 202a when liquid 101 flows into the device 100. The filters 202 & 204 inside the device 100 are designed to filter debris 128 out of the liquid 101 as a volume of liquid 101 passes into and through the device 100. The first lower interior filter 202a and first upper interior filter 204a in particular may also contain or include a chemical mixture 1104 of FIG. 11 to initiate primary breakdown of targeted varieties of debris 128, such as plastic debris 128, as soon as this debris 128 makes contact with the filters 202 and 204 of the device 100. The device 100 passing through the liquid 101 causes a portion of liquid 101 to be drawn into the stomach chamber 200 through the front aperture 106 and the front opening 126, and out again through the rear aperture 112. The filter systems 202 and 204 filter and remove debris 128 from the liquid 101, such as plastic debris 128 polluting ocean water.

The design of the interior filters 202-204 is inspired at least partially by the filter-feeding strategies of baleen whales such as blue whales, humpback whales, and fin whales. These species filter their diet of plankton out of ocean water by straining the water through the baleen plates in their mouths. The filtering effect of the invented device 100 is both mechanical, by designing corners and strainers and utilizing fluid dynamics, to allow liquid 101 to pass by but snag particulate debris 128, and also chemical, by imbuing of the filters 202-204 with chemical mixtures 1104-1106 (as presented in FIG. 11) that chemically react with targeted varieties of debris such as plastics. The filters 202-204 may also be textured or ‘feathered’ to further mechanically impede debris 128, a feature which may be especially effective in slower currents. Any means of filtering as generally known and applicable in the art or discovered in the future might be usefully employed in this context, as found suitable and useful.

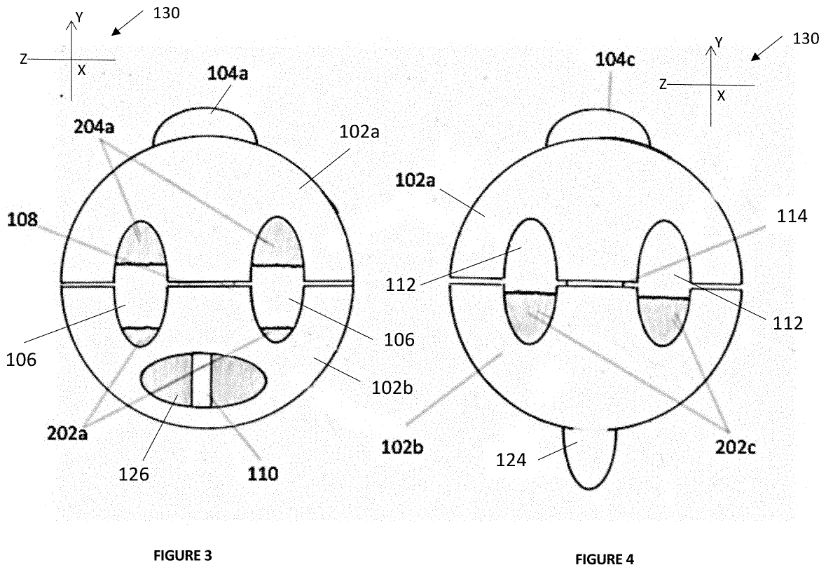

Referring now generally to the Figures and particularly to FIG. 3, FIG. 3 is a front view of the invented swimming device 100. From the front, each of two front apertures 106 are visible, and through these the frontmost filters 202a and 204a are visible. The top lens 104a will reflect the filtered light that passes through the liquid environment 101 and magnify this light through the exterior casing 102a. The upper exterior casing 102a may be lighter in pigmentation when compared to the lower exterior casing 102b, in order to allow more light to be magnified through. This magnification will heat up the interior of the invented swimming device 100 and aid the chemical mixtures 1104 and 1006 of FIG. 11 in breaking down the debris 128. It is understood that various preferred embodiments of the invention may include either a single front aperture 106 or more than one as presented here.

Referring now generally to the Figures and particularly to FIG. 4, FIG. 4 is a rear view of the invented swimming device 100, presenting two rear apertures 112. It is understood that various preferred embodiments of the invention may include either a single rear aperture 112 or more than one as presented here. The rear aperture 112 is aligned with the filters 110c so that only the heavier particles left over from the debris 128 will come into contact with the filters 204 and more of the body of liquid 101 is able to flow out of the invented swimming device 100. The rudder 124 is visible in FIG. 4 because the rudder 124 is very close to the rear of the machine. The rudder 124 is positioned on the rear of the exterior casing 102b in order to help the invented swimming device 100 remain upright while moving through the body of liquid 101.

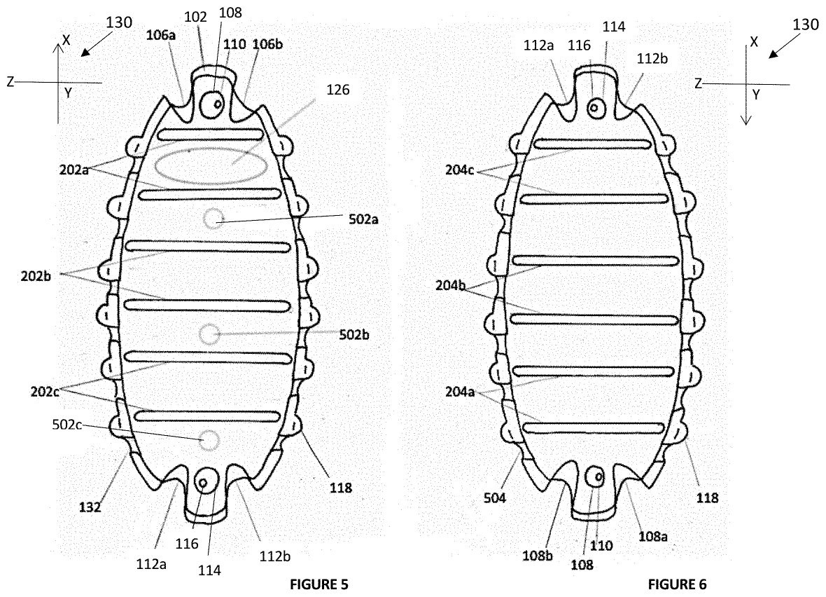

Referring now generally to the Figures and particularly to FIGS. 5 & 6, FIGS. 5 & 6 are a top view of the interior of the two sides of the casing 102 of the invented device 100, as the device 100 may appear if the casing 102 were decoupled and the two halves laid flat upon a table (with one of the halves also turned around, as the front and back ends of FIGS. 5 and 6 are not pointing the same direction). In another embodiment, the exterior casing 102 may be more cylindrical or elongated with hard edges to form a rectangular shape. These embodiments would be used in situations such as extra attachments in water treatment, in the case of water treatment facilities or consumer water treatment devices. In FIG. 5 is a view of the bottom exterior casing 102b, and FIG. 6 is a view of the top exterior casing 102a. A plurality of attachment points 502 for inclusion of the exterior filters 1304 of FIG. 13 are marked in FIG. 5 along the underside of the device 100 bottom exterior casing 102b. A plurality of holes 504 in the exterior casings 102 are present to allow for the paddles 120a-122k to fit through the exterior casings and align with the other side of the exterior casings, so that the paddles 120a-122k are exposed to the body of liquid 101 on either side of the invented deice 100. The plurality of raised bumps 118 are set directly in front of the plurality of holes 504 in order to limit the movement of the paddles system 120a-122k. Interior filters 202 and 204 are arranged in rows to allow for the surrounding liquid 101 to move over them and maximize the surface area of the interior filters 202 and 204 that come into contact with the body of liquid 101.

The additional front opening 126 is cut out of the exterior casing 102b. This additional opening 126 will allow for the body of liquid 101 that comes into the invented swimming device 100 to flow into the casing 102 more freely than the liquid can leave through the rear aperture(s) 112. The front aperture 106 can be divided into two holes, 106a and 106b. These two holes limit the amount of the body of liquid 101 that can enter the invented swimming device 100 and redirect the body of liquid 101 toward the interior filters 204a in order to maximize the amount of the debris 128 that comes into contact with the chemical mixture 1104 of FIG. 11. The rear aperture 112 is divided into two holes, 112a and 112b, in order to redirect the flow of the body of liquid 11 toward the interior filters 202c and 204c and filter out any remaining debris 128.

Referring now generally to the Figures and particularly to FIG. 6, FIG. 6 is a top view of the exterior casing 102a of the invented swimming device 100. To give an example of a size measurement believed to be preferable, a current prototype is modeled to be 69.16 millimeters wide without the paddles 134-154 and 147 millimeters wide with the added length of the paddles 120a-122k. The exterior casings 102 of the invented swimming device 100 is currently modeled at 144.25 millimeters long but can scale up to any larger size. The exterior casings 102 of the invented swimming device 100 are currently modeled at 72.39 millimeters tall but can scale up to any larger size. This is only a single example based on prototype models currently being tested, and should not be construed as limiting; the device 100 can be scaled to any suitable size. It is noted that in a small body of liquid 101, such as a swimming pool or pipeline, a large device 100 may not be preferable, as the efficacy of the device 100 relies at least partially on the device 100 moving around, but a large body of water 101 like the ocean might easily accommodate a larger device 101 if such was found to be more effective. It is noted also that scaling of the device 100 may also entail shifts in design such as providing of more or differently positioned apertures 106 & 112 and filters 202 & 204. One skilled in the art recognizes that a great deal of variation on this basic model is possible and obvious, and that specific device 100 design can be tailored to suit the environment and liquid 101 being traversed and filtered. Particularly for an environment in which prolific use of this device is anticipated, such as the ocean, it could be sensible to build specialist embodiments of the device with features and scaling particularly tailored to specialize in that environment, in addition to more generalist embodiments that might be employed decently well in a wider variety of liquid environments. The ocean alone is large enough that it may even be useful to build devices specializing in different subsections of this environment, such as deeper depths, different speeds of current, or different pollution specializations such as being tailor-made for cleaning up a specific size or variety of plastic such as an especially common kind.

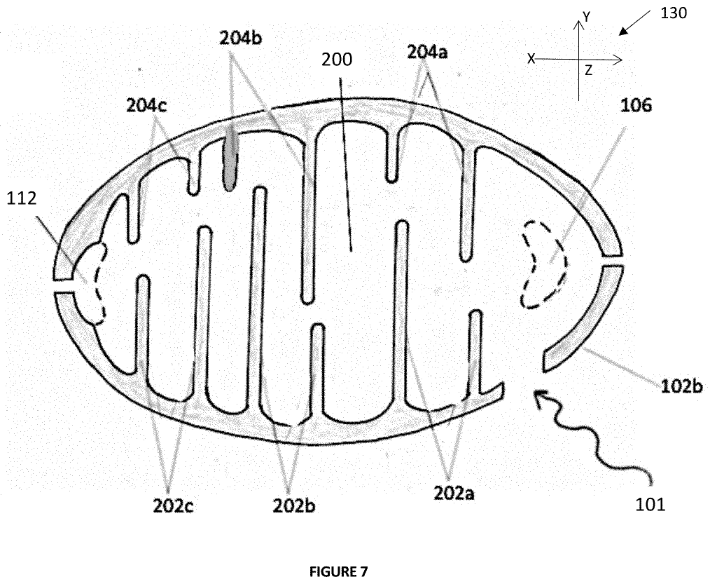

Referring now generally to the Figures and particularly to FIG. 7, FIG. 7 is a side view of the interior filters 202 and 204 set inside the stomach chamber 200. The body of liquid 101 can enter the invented swimming device 100 through the front aperture 106 and the front opening 126. The body of liquid 101 will then come into contact with the filters 202a and 204a which contain the chemical mixture 1104 of FIG. 11.

Referring now generally to the Figures and particularly to FIG. 8, FIG. 8 is an interior view of the front of the invented swimming device 100, as the device 100 might appear if one were able to see through the casing 102 while viewing the device 100 from the front. The two exterior casings 102a and 102b are held together by the locking mechanism consisting of the smaller cylinder 110 slotting into the larger cylinder 108. The lens 104a could be placed near the front aperture 106 in order to warm liquid 101 that enters through the front aperture 106. This liquid would then be heated up when in contact with the filters 202a and 204a. An alternative locking mechanism for the exterior casings 102 would be applied by exchanging the smaller cylinder 112 for the biodegradable screw 1306 of FIG. 13.

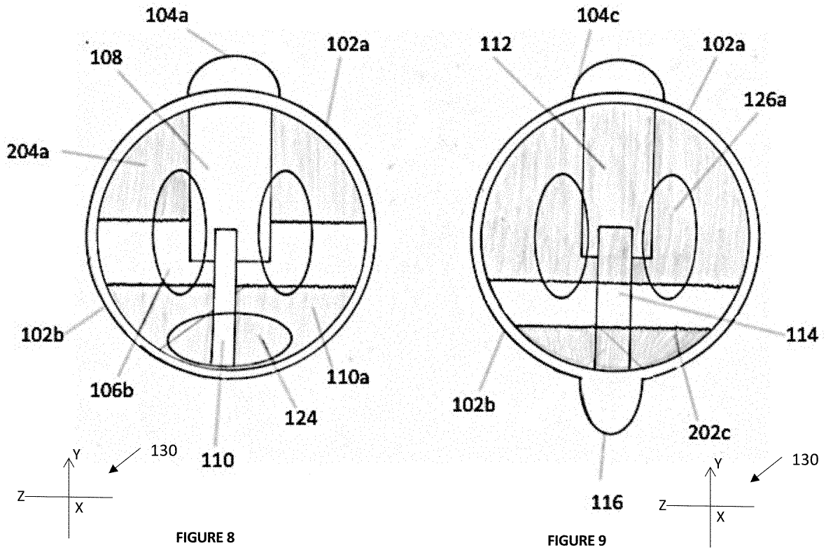

Referring now generally to the Figures and particularly to FIG. 9, FIG. 9 is an interior view of the back of the invented swimming device 100, as the device 100 might appear if one were able to see through the casing 102 while viewing the device 100 from the rear. The two exterior casings 102a and 102b are held together by the locking mechanism consisting of the smaller cylinder 114 slotting into the larger cylinder 112. The top lens 104c is positioned over interior filters 202c and the interior filters 204c in order to warm any liquid that enters through the rear apertures 112. The exterior casing 102a may have less pigment in order to allow for more light to shine through and increase available warming. The rudder 124 is positioned at the rear of the invented swimming device 100 in order to assist in stability while the invented swimming device 100 is traveling through the body of liquid 101.

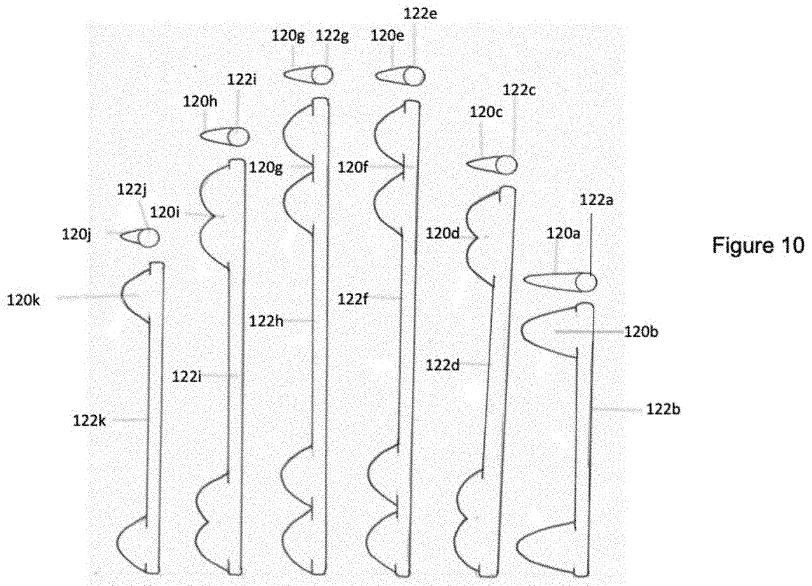

Referring now generally to the Figures and particularly to FIG. 10, FIG. 10 presents top and side views of each of the individual paddles 120a-122k, detached from the device 100. The paddles 120a-122k vary in lengths, which allows them to align with the curved shape of the exterior casings 102. It is strongly preferred that the sizes of the paddles 120a-122k align precisely with the size of the invented swimming device 100, and therefore that the paddle sizes scale with the rest of the invented swimming device 100. In the prototype model mentioned throughout these Figures, the paddles 120a-122k measure as follows: 83.5 millimeters long and 22.5 millimeters wide for paddle 122a, 20.5 millimeters long and 14.06 millimeters wide for paddle 122c, 146 millimeters long and 14.06 millimeters wide for paddle 122e, 147 millimeters long and 14.38 millimeters wide for paddle 122g, 128 millimeters long and 15 millimeters wide for paddle 122i, and 95.89 millimeters long and 13.75 millimeters wide for paddle 122j. Paddles 122c-122i have a divide between a set of blades 120a-120h. The divide between the blades 120a-120h allows for more of the body of liquid 101 to flow between them. These divides may be eliminated in another embodiment of the invented swimming device 100. The purpose of the divides is purely cosmetic and in fact reduces the amount of the body of liquid 101 that passes over them, potentially slowing the invented swimming device 100. For bodies of liquid that possess a strong current system, such as river systems, this divide may be deepened to limit drag and slow the overall speed of the invented swimming device 100.

Referring now generally to the Figures and particularly to FIG. 11, FIG. 11 is a diagram of the chemical reactions that occur within the stomach chamber 200 and/or the exterior filters 1304 of FIG. 13, wherein each element of the chemical reaction process is represented abstractly as a different shape. The debris 128 comes into contact with the filter system 202-204 and is affected by a first chemical mixture 1104 present on or in the filters 202-204. This first chemical mixture 1104 enacts a chemical reaction with the debris 128, dissolving the debris 128 into a first byproduct 1108. Depending upon the composition of the first chemical mixture 1104, or on the particular kind of debris 128, the first byproduct 1108 may be an intermediate step, and may be further acted upon in turn by a second chemical mixture 1106, which turns the first byproduct 1108 into one or more second byproducts 1110 and 1112. In preferred embodiments of the invention, the first chemical mixture 1104 might be present on the frontward filters 202, and the second chemical mixture 1106 on the rearward filters 204, such that liquid 101 passing through the device 101 carries the debris 128 through one after the other and then carries the byproduct(s) out through the rear aperture(s) 112.

The first chemical mixture 1104 & second chemical mixture 1106 of the invented swimming device 100 may preferably contain enzymes from the mushroom Trametes versicolor, from the bacterial family Comamonadaceae, from the bacterial class Pseudomonas, and from other bacterial and fungal families that have been proven to break down plastic. While development of the invention remains ongoing and further preferred chemical and enzyme elements are still being identified and incorporated, a few key ingredients for application in the chemical processes of the invention are already selected. These include, but are not limited to, enzymes expressed from Ideonella sakaiensis F-6, laccase from multiple sources, manganese peroxidase from multiple sources, enzymes found in Trichoderma sp., lipase from multiple sources, chemicals expressed from Escherichia coli BL21, enzymes expressed from the bacteria Delftia acidovorans, protease from multiple sources, serine hydrolases from multiple sources, putative polyurethanes from multiple sources, and multiple expression from the bacterial genus Thermobifida. One skilled in the art will recognize that this is not a comprehensive list of potentially applicable enzymes, chemicals, or substances that might be utilized in this context, and also that the formula might usefully be modified or tailored depending on the varieties of debris 128 that the device 100 is likely to encounter most, or depending on what one prefers the byproduct of the process to be. Further, one recognizes that some enzymes, chemicals, or substances may themselves be pollutants or environmental hazards. As preferred embodiments of the invented device can be abandoned at sea to swim around and dissolve trash until they fall apart or even get ingested by an ocean creature, inclusion of pollutant, unsafe, or toxic chemicals, even to the end of reducing other pollutants, is a discouraged embodiment, particularly with less-impactive options available.

Referring now generally to the Figures and particularly to FIG. 12, FIG. 12 presents two alternative features that might be positioned atop the invented device 104, in the positions occupied by the lenses 104 in FIG. 1 and subsequent related Figures. FIG. 12 presents one of the lenses 104, alongside a gas-filled sac 1202, which may replace one or more lenses 104 in position on top of the device 100 as presented in FIG. 1 and others, in certain alternative preferred embodiments of the invented device 100. A preferred embodiment utilizing gas-filled sacs 1202 might use oxygen as a gas 1204 that will fill the gas-filled sacs 1202. Preferably, the oxygen is introduced into the gas-filled sacs 1202 during production, so that no piercing of the sacs 1202 is involved, in order to prevent leakage and maximize buoyancy. Another gas 1204 that could fill the gas-filled sacs 1202 would be the atmosphere in the location of production, so that no extra steps are added to production but the desire to increase buoyancy in the invented swimming device 100 remains fulfilled. It is noted that any substance that is gaseous at the temperatures generally found in the environment 101 the device 100 will be traversing may be acceptable for the purpose of providing buoyancy, and that certain gases 1204 are more easily available for such everyday uses than others and no rare or special gas is necessary here but any gaseous material suitable for providing the property of flotation in liquid may be utilized here. Further, embodiments of the invented device 100 intended for traversing liquid environments 101 such as deeper ocean depths, where the temperature is lower and the surrounding environmental pressure is sufficient to affect air pressure inside a submerged vessel containing air, might be adapted accordingly to account for this at least by utilizing a gas 1204 having a low condensation temperature. The sacs 1202 may be made of any suitable material for enclosing air, with a strong preference for biodegradable material. In certain preferred embodiments, the material of the sac 1202 might be translucent, such that at least some benefit and function of having lenses 104 is also achieved.

The gas-filled sac 1202 may be placed in the location of every lens 104 in order to allow for both magnification and buoyancy. The gas-filled sacs 1202 can be made of the same material as exterior casings 102. The lenses 104 and the gas-filled sacs 1202 may be omitted from exterior casing 102a in order to allow for exterior casing 102a to be produced with the same pigment as casing 102b. This modification does not allow for the heating of the stomach chamber 200 through magnification. Additional embodiments of the invented device 100 intended to remain anchored to one spot, such as in water treatment facilities or consumer water filters, may have no sacs 1202 at all.

Referring now generally to the Figures and particularly to FIG. 13, FIG. 13 is a side view of a second invented device 1300. This embodiment includes several distinct features such as a second bottom exterior casing 1302 that is smaller than the top exterior casing 102a, a plurality of exterior filters 1304, and a plurality of screws 1306. The screws 1306 are preferably biodegradable, such as being made of the same material as the casing, or otherwise non-polluting and safe to abandon at sea; a non-biodegradable screw should be viewed as a possible and anticipated embodiment, but inappropriate for the preferred ocean-going application at least because the goal is to remove pollution from the environment, not add more. It is noted that some materials that are non-biodegradable but may otherwise predictably fall apart or substantially degrade and disintegrate at sea, such as low-carbon steel, may also be found suitable for such an application. The screws 1306 are coupled to the exterior casing, preferably at the attachment points 502, such that the external filters 1304 hang down from the second device 1300. The casing 102 may be manufactured with attachment points 502 already included, but as a tight fit for the screws 1106 is preferred, one may also simply puncture the casing 102 when attaching the screws 1106. The screws 1306 may also be used as an alternative means for coupling other portions of the device together, such as replacing or partially replacing the cylinder assemblies 108/110 and 114/116 coupling the casing 102 halves together. The second device 1300 may still include some or all of the features previously recited as part of the first device 100, such as interior filters 202-204. In this embodiment, the exterior filters 1304 may provide some additional ballast and stability and render the rudder 124 unnecessary.

The design of the second device 1300 is inspired at least in part by the feeding style of a jellyfish, filtering and applying chemical mixtures 1104-1106 to the contents of the liquid 101 in proximity to the external filters 1304. One noted benefit of this second embodiment is improved ability to filter a body of liquid 101 that's mostly still, such as a lake or reservoir.

Other embodiments of the device may allow for the inverse ratio of the top and bottom exterior casings, or for the exterior casing 102b to be made smaller, but these alterations are needed for specific environments. For instance, if the body of liquid 101 is enclosed inside an open section of piping and the interior filter 202a must be used as a plug while the interior filter 102b filters the liquid that passes through the pipe or other narrow space. Another application could be if the invented swimming device 100 is meant to operate in deeper waters, such as trenches inside the Atlantic coast. Then the exterior casing 102b would be much smaller, only large enough to accommodate the exterior filters 1304. If the invented swimming device 100 is meant to float inside of a pool or man-made water structure meant for decorative or leisurely activities, then the interior filter 102a may be smaller than the interior filter 102b while the lenses 104 would be larger, in order to allow the invented swimming device to sit on top of the body of liquid 101 and draw as much energy from the light as possible, to maximally heat the stomach chamber 200. The exterior filters 1304 may be attached to the exterior casing 102b. The exterior filters 1304 would extend down below the invented swimming device 100 in order to catch the plastic debris 1102 deeper in the surrounding body of liquid 101. The casing 102a may be larger than casing 102b if the exterior filters 1304 are added to the bottom of the exterior case 102b, turning this element into the second bottom exterior casing 1302.

If the exterior filters 1304 are included they will preferably be coupled to the exterior casing 1302 by the screws 1306, though other suitable means of coupling as generally known in the art may also be acceptable.

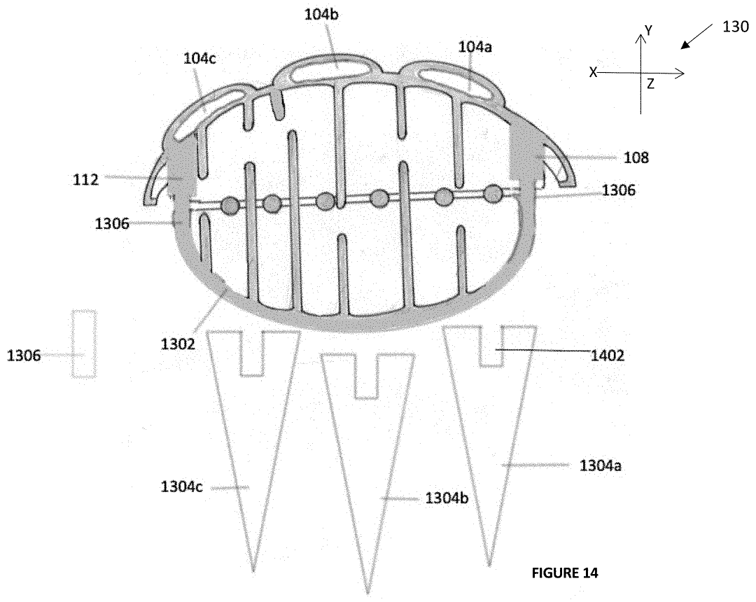

Referring now generally to the Figures and particularly to FIG. 14, FIG. 14 is an exploded internal side view of the invented swimming device 100 with the exterior filters 1304 attached by the screws 1306. The screws 1306 are screwed in from the exterior casing 102b, at the points 502, down into the exterior filters 1304 in order to maximize the space available inside the stomach chamber 200.

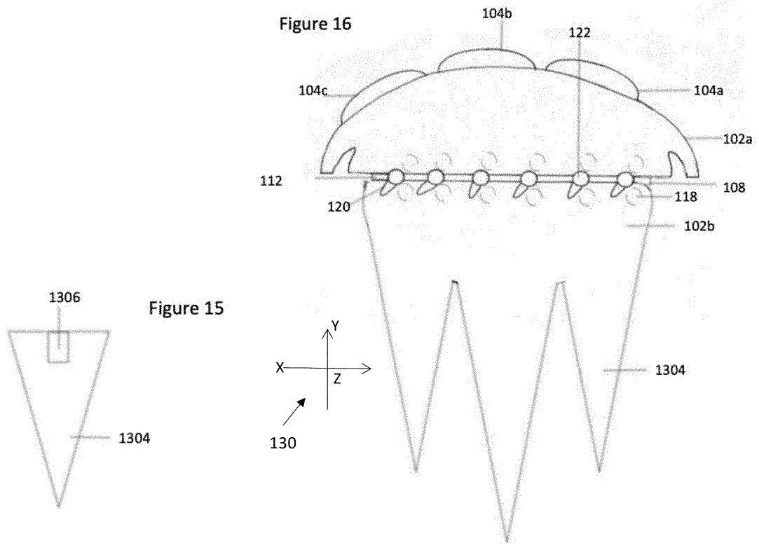

Referring now generally to the Figures and particularly to FIG. 15, FIG. 15 is a diagram of one of the exterior filters 1304 with the biodegradable screw 1306 attached. In the prototype on which these Figures are based, the exterior filter 1304 currently measures 174 millimeters long. This measurement is included as a disclosure of what is believed to be a sound approach to building a preferred embodiment of the invention, but it is recognized that the exterior filters are also scalable to various sizes and this shouldn't be construed as limiting.

Referring now generally to the Figures and particularly to FIG. 16, FIG. 16 is a side view of the invented swimming device 100 with the exterior filters 1304 attached to the exterior casing 1302 by manufacture, resulting in a unitary piece. The entire exterior casing 102b, which includes the exterior filters 1304, is attached to the exterior casing 102a through the biodegradable screws 1306 being inserted into the larger cylinders 108 and 112.

It is strongly preferred that the material be biodegradable in order to allow for the invented swimming device 100 to fully degrade in the surrounding body of liquid 101. This degradation is crucial for the invented swimming device 100 to impact the environments that the device 100 travels through as little as possible. If the invented swimming device 100 remains in oceanic or other marine environments, rather than decomposing, the possibility of contamination from one or more chemical mixtures 1104 and 1106 or from intermediate byproducts 1108, or further pollution of the environment with undissolved pieces of the device 100, may be too high for use of the invented device to actually benefit the marine environment instead of cause further harm. Most preferred embodiments of the invented swimming device 100 must also biodegrade because the chemical mixtures 1104 and 1106 cannot be replenished while the invented swimming device 100 is in the body of liquid 101, and one may have to re-catch the device 100 to replenish these, which would add a lot of manual work to any plan of using these invented devices to clean the whole ocean. When the chemical mixtures 1104 and 1106 are depleted, the invented swimming device 100 may no longer be able to break down debris 128. It is possible to produce the invented swimming device out of non-biodegradable materials, but that is not advisable for the aforementioned reasons. However, in cases where the invented swimming device 100 is in a consumer's or facility's care, such as in a water treatment facility or swimming pool sort of application, and is intended to be used for a prolonged period of time, the invented swimming device 100 might be produced out of non-biodegradable materials to improve its longevity.

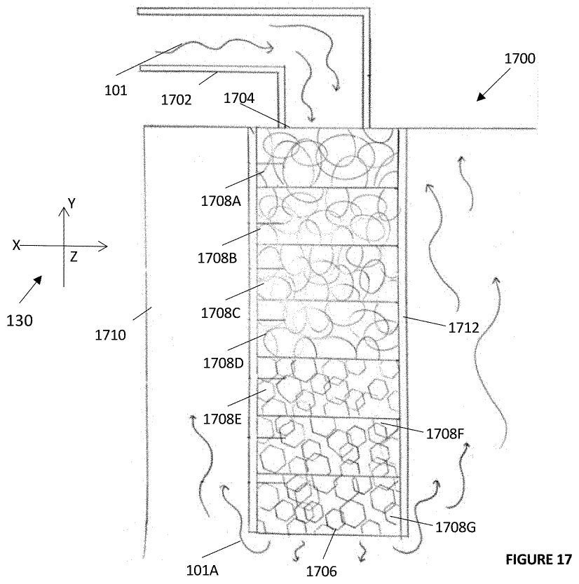

Referring now generally to the Figures and particularly to FIG. 17, FIG. 17 is a side view of a third invented device 1700, which is a stationary embodiment of the invention. This embodiment is directed toward applying the novel approach and methodology of the invention to stationary filtration fixtures also, such as but not limited to improving the functionality of municipal water treatment facilities. In preferred operation, the third invented device 1700 is installed such that liquid 101 is able to flow from a storage tank, consumer device, or pipe 1702 as presented here, downward into an upper end 1704 and toward a lower end 1706. The fluid 101 is then able to travel vertically down through a series of stationary filters 1708A through 1708G (individually, a first stationary filter 1708A, a second stationary filter 1708B, a third stationary filter 1708C, a fourth stationary filter 1708D, a fifth stationary filter 1708E, a sixth stationary filter 1708F, and a seventh stationary filter 1708G) and beyond, into a storage tank 1710 as presented here, a consumer device, or a second pipe. The series of stationary filters 1708A through 1708G may preferably contain an assortment or plurality of different enzymes, bacteria, fungi, chemical elements, and similar selected to extract certain kinds of pollutants from the liquid 101, and are preferably arranged and configured such that unfiltered liquid cannot pass through without removal of the pollutants if present. It is noted that, while most filtering means as generally known in everyday life—such as a flour sieve, a carbon filter for drinking water, or a dust mask—operate on a principle of forming meshes of very small holes that undesired particles cannot pass through but preferred elements can (or vice versa), this series of stationary filters 1708A through 1708G may operate significantly differently, as the principle being applied is not that the pollutive elements will be trapped in a net and unable to pass, but that these pollutive elements will be consumed in organic or chemical processes and excreted as something else. As such, mesh or net structures may not even be necessary or preferred for this application, depending on how quickly such processes can be caused to occur. A casing 1712 around the series of stationary filters 1708A through 1708G is provided to restrict egress of the liquid 101 until the filtering processes are complete, whereupon a volume of now-filtered liquid 101A flows out through the lower end 1706, making room for more liquid 101 to flow in through the upper end 1704 and be filtered. It is noted that additional markings may be included on the third invented device 1700 or casing 1712, such as lines to aid in measurement or more easily distinguish filtering sections. It is further noted that, while seven layers of filtering (namely, the series of stationary filters 1708A through 1708G) are presented here, the third invented device 1700 may contain more or fewer layers of filtering.

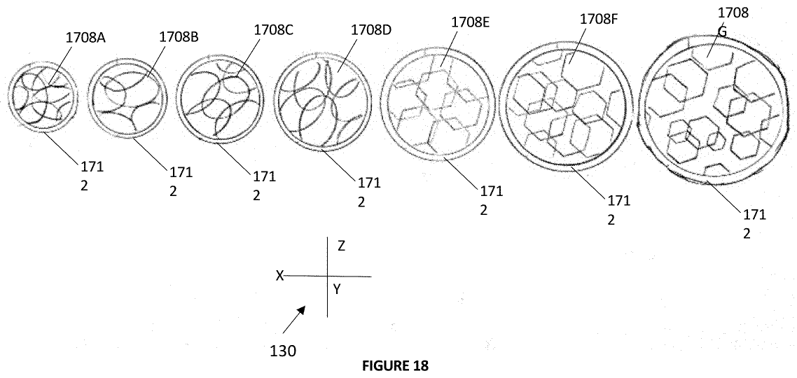

Referring now generally to the Figures and particularly to FIG. 18, FIG. 18 is a top view presenting separately each of the series of stationary filters 1708A through 1708G of FIG. 17, as though these elements were removed from the third invented device 1700 and laid out on a table. The series of stationary filters 1708A through 1708G are covered by a protective casing 1712 around the series of stationary filters 1708A through 1708G, to restrict egress of the liquid 101 until the filtering processes of the series of stationary filters 1708A through 1708G are complete. It is noted that, as the third invented device 1700 is generally anchored down and kept in a consumer's or facility's care and used for a prolonged period of time, this is an instance of the invented device that may allow for use of some non-biodegradable materials for improved longevity and durability. However, it is further noted that use of biodegradable or nontoxic materials may still reduce potential for introduction of any new pollutants to the filtered liquid 101A after filtration, and also may make it easier to responsibly dispose of the third invented device 1700 at end of life. Preferred biodegradable materials may include pressed mycelium or a plastic mixture embedded with the necessary enzymes to break the protective casing 1712 down when the consumer or facility deems it necessary. The filters 1708A through 1708G are preferably made of a mesh of a cellulose and chitosan mixture or of a fully cellulose mesh. The series of stationary filters 1708A through 1708G are each preferably made of a mesh of mycelium from the mushroom Trametes versicolor and may preferably contain enzymes from the mushroom Trametes versicolor. As an example of a course of biochemical filtration as instantiated in the pollutant-consuming elements of the series of filters 1708A through 1708G, the following series of biochemical elements may be one preferred formula as currently understood. The first stationary filter 1708A is preferably impregnated with putative polyurethanes from multiple sources, and multiple expression from the bacterial species Thermobifida. The second stationary filter 1708B is preferably impregnated with enzymes expressed from Ideonella sakaiensis F-6, laccase from multiple sources, and from the bacterial family Comamonadaceae. The third stationary filter 1708C is preferably impregnated with manganese peroxidase from multiple sources and enzymes found in Trichoderma sp., from the bacterial class Pseudomonas, and from other bacterial and fungal families that have been proven to break down plastic. The fourth stationary filter 1708D is preferably impregnated with chemicals expressed from Escherichia coli BL21 and enzymes expressed from the bacteria Delftia acidovorans. The fifth stationary filter 1708E is preferably impregnated with lipase from multiple sources and enzymes expressed from Ideonella sakaiensis F-6 and laccase from multiple sources. The sixth stationary filter 1708F is preferably impregnated with lipase from multiple sources, protease from multiple sources, and serine hydrolases from multiple sources. The seventh stationary filter 1708G is preferably impregnated with the necessary chemicals to finish any secondary breakdown, which can be modified or tailored depending on the varieties of debris 128 that the third invented device 1700 is considered likely to encounter most, or depending on what one prefers the byproduct of the process to be. It is noted that a similar formula, combination, or sequence to this one might be utilized also as the chemical mixtures 1104 and 1106 of other embodiments of the invention.

One skilled in the art will recognize that this disclosure does not contain a comprehensive list of potentially applicable enzymes, chemicals, or substances that might be utilized in this context. Applicant offers the present disclosure to illuminate how best to practice the invention as currently understood, and recognizes that substantial further development may lie ahead to improve and optimize the invention as presently understood. Variation of the types and applications of these various biochemical filtration elements, and discovery of previously unknown such elements to try, may be a particularly productive direction in which to further experiment.

While selected embodiments have been chosen to illustrate the invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment, it is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

I claim:

1. A device for filtering solid matter out of a body of liquid, the device comprising:
a. an exterior casing;
b. a filtering element; and
c. an internal repository for containing a plurality of gathered solid matter filtered from the surrounding body of liquid.

2. The device of claim 1, wherein the internal repository contains chemical elements which interact with the plurality of gathered solid matter.

3. The device of claim 2, wherein an interaction of the chemical elements with the plurality of gathered solid matter constitutes a chemical reducing of the gathered solid matter into a preferred byproduct.

4. The device of claim 2, wherein the chemical elements are selected from the group of: enzymes, bacteria, fungi, biological proteins, and nonhazardous chemical compounds.

5. The device of claim 4, wherein the gathered solid matter consists mostly of plastics, and the chemical elements are selected from at least the group of: enzymes from the mushroom Trametes versicolor, enzymes from the bacterial family Amycloptis, enzymes from the bacterial family Comamonadaceae, and enzymes from the bacterial class Pseudomonas, enzymes expressed from Ideonella sakaiensis F-6, laccase, manganese peroxidase, enzymes found in Trichoderma sp., lipase, chemicals expressed from Escherichia coli BL21, enzymes expressed from the bacteria Delftia acidovorans, protease, serine hydrolases, putative polyurethanes, and multiple expressions from the bacterial species Thermobifida.

6. The device of claim 1, wherein all components and chemicals of the device are biodegradable and non-toxic.

7. The device of claim 1, wherein the filtering element is structured to emulate filter-feeding means as adapted by one or more aquatic organisms.

8. The device of claim 1, the external casing further comprising one or more apertures.

9. The device of claim 8, wherein the filtering element is positioned within an open central cavity accessible through the one or more apertures of the external casing, such that the body of liquid flows in through the one or more apertures of the external casing and through the open central cavity of the device, and solid matter present within the body of liquid is exposed to the filtering element while moving through the open central cavity along with the body of liquid.

10. The device of claim 9, wherein the filtering element consists of a plurality of plates of material positioned to partially obstruct the open central cavity of the device.

11. The device of claim 9, wherein one or more surfaces of the open central cavity is further layered with a chemical element selected from the group of: enzymes, bacteria, fungi, biological proteins, and nonhazardous chemical compounds.

12. The device of claim 1, the external casing further comprising one or more translucent sections.

13. The device of claim 1, further comprising one or more hanging elements positioned on an underside of the outside of the external casing, and layered with a chemical element selected from the group of: enzymes, bacteria, fungi, biological proteins, and nonhazardous chemical compounds.

14. The device of claim 1, wherein the device is anchored to a fixed position.

15. The device of claim 1, wherein the device is non-anchored and mobile.

16. The device of claim 15, further comprising one or more paddles for effecting stable movement of the device within the body of liquid.

17. The device of claim 16, further including a plurality of bumps on the external casing, such that the paddles are free to propel the device toward a selected direction in response to wave motion within the body of liquid, but are inhibited by the bumps from propelling the device away from the selected direction in response to wave motion within the body of liquid.

18. The device of claim 15, further comprising a rudder element.

19. A device for filtering solid matter out of a body of liquid and chemically processing the filtered solid matter, the device comprising:
an external casing;
a filtering element;
an internal repository for containing the solid matter once filtered out of the body of liquid;
a chemical element contained within the internal repository suitable for chemically processing the solid matter once filtered from the body of liquid, selected from the group of consisting of enzymes, bacteria, fungi, biological proteins, and nonhazardous chemical compounds.

20. A method for utilizing a device for reducing debris dissolved within a body of liquid, the device comprising an exterior casing, a filtering element, an internal repository for containing a plurality of gathered debris filtered from the body of liquid, and a chemical element for dissolving the plurality of gathered debris, the method comprising:
exposing a volume of the body of liquid to the filtering element of the device;
allowing the debris filtered out of the body of liquid by the filtering element to encounter the chemical element, and the chemical element to dissolve the debris into a preferred byproduct;
allowing the preferred byproduct to flow back out into the body of liquid.
